(19) United States
(12) Patent Application Publication
(10) Pub. No.: US 2018/0009406 A1
(43) Pub. Date: Jan. 11, 2018

(54) PYROTECHNIC GAS GENERATOR AND CORRESPONDING CHILDCARE DEVICE

(71) Applicant: DOREL JUVENILE GROUP, INC., Foxboro, MA (US)

(72) Inventors: Nicolas GARNIER, Saint Germain Sur Moine (FR); Haja RABEONY, Cholet (FR)

(21) Appl. No.: 15/544,897

(22) PCT Filed: Jan. 11, 2016
(86) PCT No.: PCT/EP2016/050335

§ 371 Date: Jul. 20, 2017

(30) Foreign Application Priority Data
Jan. 23, 2015 (FR) 1550551

(51) Int. Cl. B60R 21/274; B60R 21/18; B60R 21/207; B60R 22/28

(52) U.S. Cl. CPC B60R 21/274; B60R 21/2072; B60R 21/18; B60R 22/28

(57) ABSTRACT

The present disclosure relates to a gas generator for airbag(s) including: at least one pyrotechnic charge and a system for igniting/activating said charge triggered during a predetermined condition.

The field of the invention is that of child care, and more precisely of devices able to receive a child, in particular in seated position.

The invention in particular relates to car seats, intended to be fastened to a seat or a bench seat of a motor vehicle. It can also be implemented in devices such as strollers, nacelles, seats for bicycles, etc.

Further more precisely, the invention relates to the implementation of bags, or balloons, or elements, for safety that can be inflated, commonly referred to as “airbag”, of which the inflating is triggered automatically in case of impact (in an accident situation), in order to protect the child installed in the child care device.

The use of “airbags” is well known, in particular in the field of the automobile. More recently, many other applications have been considered, and in particular for child car seats.

For example, the car seat can include two airbags, housed on or in the shoulder straps of a harness or on or in sheaths mounted on said shoulder straps, and which can be fastened using means of connection. Such an approach is described for example in patent document FR2969055, in the name of the Holder of this patent application.

In the event of impact, each one of the airbags is inflated by a gas coming from a bottle of pressurised gas and transmitted via a passage for the circulation of the pressurised gas.

Documents describing airbags for car seats generally provide for the presence of means for detecting impacts that control the triggering of gas generating means intended for the inflating of airbags, but do not provide any precision on the operation of these gas generating means, and in particular on the way in which the gas is conveyed. This is however a crucial problem. Indeed, it is essential that the airbags are triggered systematically when this is necessary, and sufficiently rapidly in order to provide for the protection of the child.

It is furthermore essential that these gas generating means be of simple design and have optimum compactness.

Similar problems are encountered in other child care devices.

The invention has in particular for object to overcome at least some of these disadvantages.

An objective of the invention is to provide an inflating gas to one or several airbags in a reliable manner.

More precisely, an objective of the invention is to perfect the known gas generating means in order to simplify their structure and optimise their compactness.

Another objective of the invention is to provide such gas generating means that are relatively inexpensive.

Another objective of the invention is to provide a child care device that improves the safety of the child in case of impact, simply and effectively.

Another objective of the invention, at least according to certain embodiments, is to provide a car seat that provides a reliable, safe and effective triggering of the airbag or airbags, when an accident situation occurs.

These objectives, as well as others which shall appear in what follows are achieved using a gas generator for airbag(s) comprising:
at least one pyrotechnic charge and means for igniting/activating said charge triggered during a predetermined condition,
a reservoir containing a pressurised gas and of which the mouth is closed by a sealing member, and
an opening for evacuating gases that communicates with at least one airbag.

According to the invention, the gas generator further comprises a striker located in a duct wherein exits the opening for evacuating gases and which can be displaced in a first step, when the predetermined condition is fulfilled, by the combustion gases generated by the pyrotechnic charge in the direction of the sealing member, from an initial position to an open position, so as to pierce the latter using means for piercing carried by said striker, said striker able to be returned, once the sealing member has been pierced, by the pressurised gas stored in the reservoir, to the initial position, with the pressurised gas escaping from the reservoir to said opening for evacuating gases.

It is as such possible to provide an inflating gas to one or several airbags in a reliable manner using a gas generator structure that is simple and compact.

In addition, such a structure makes it possible to limit the deployment time of the airbags.

The pyrotechnic gas generator in accordance with the invention uses a solid agent for the production of combustion gas, as a source of displacement of a striker to a bottle of pressurised gas. A front end of the striker is used to pierce the closing seal of the bottle of pressurised gas.

Once the bottle has been pierced, the pressurised gas causes the displacement of the striker in the opposite direction, the retracting of the striker allowing the pressurised gas to be directed to an opening for evacuating gases that communicates with the airbag or airbags. The gas stored under pressure in the bottle is as such released in order to inflate/deploy the bag or bags.

Such a gas generator structure furthermore has a reduced weight.

According to a particular aspect of the invention, in the initial position, the striker is located on one side of the opening for evacuating gases, with the mouth of the reservoir being located on the other side of the opening for evacuating gases in the duct.

According to a particular aspect of the invention, the means for piercing are surrounded by a shoulder intended to abut against the edges of the mouth of the reservoir, with the means for piercing being sized to penetrate at least partially into said mouth of the reservoir.

According to a particular aspect of the invention, the pyrotechnic charge is arranged at least partially in a housing arranged in said striker.

According to a particular aspect of the invention, the housing exits onto a rear face of the striker and the means for piercing onto the opposite front face of the striker.

According to a particular aspect of the invention, when the shoulder is abutting against the edges of the mouth of the reservoir, the rear face of the striker is located opposite the opening for evacuating gases in such a way as to define a passage for the combustion gases to the opening for evacuating gases.

According to a particular aspect of the invention, the longitudinal axis of the opening for evacuating gases is substantially inclined in relation to the axis perpendicular to the longitudinal axis of the duct.

According to a particular aspect of the invention, the means for piercing has an ogive shape or a bevelled shape.

The invention also relates to a child care device able to receive a child comprising at least one gas generator such as described hereinabove.

According to a particular aspect of the invention, the child care device comprises a harness having two shoulder straps intended to be extended from the shoulders along the torso of a child, with each one of the shoulder straps bearing an inflatable safety element, able to be inflated in the case of an impact greater than a predetermined threshold.

The implementation of these inflatable elements associated with the shoulder straps is simple to implement and use.

According to a particular aspect of the invention, the child care device comprises a seat, said gas generator being housed in the seat back, in at least one of the lateral flanks, and/or in the base of said seat.

Said inflatable safety elements can be supplied by at least one source of fluid, for example housed in the seat back of said seat, in the lateral flanks, in the base, etc.

According to a particular aspect of the invention, the child care device is a car seat, a stroller, a nacelle, or a seat for a bicycle, for example.

Other characteristics and advantages of the invention shall appear more clearly when reading the following description of a preferred embodiment of the invention, provided simply for the purposes of illustration and in no way limiting, and the annexed drawings among which:

FIG. 1 shows an example of a car seat implementing a pyrotechnic gas generator in accordance with the invention intended to inflate inflatable elements carried by the harness of the car seat;

FIG. 2 shows the car seat of FIG. 1, the inflatable elements having been deployed;

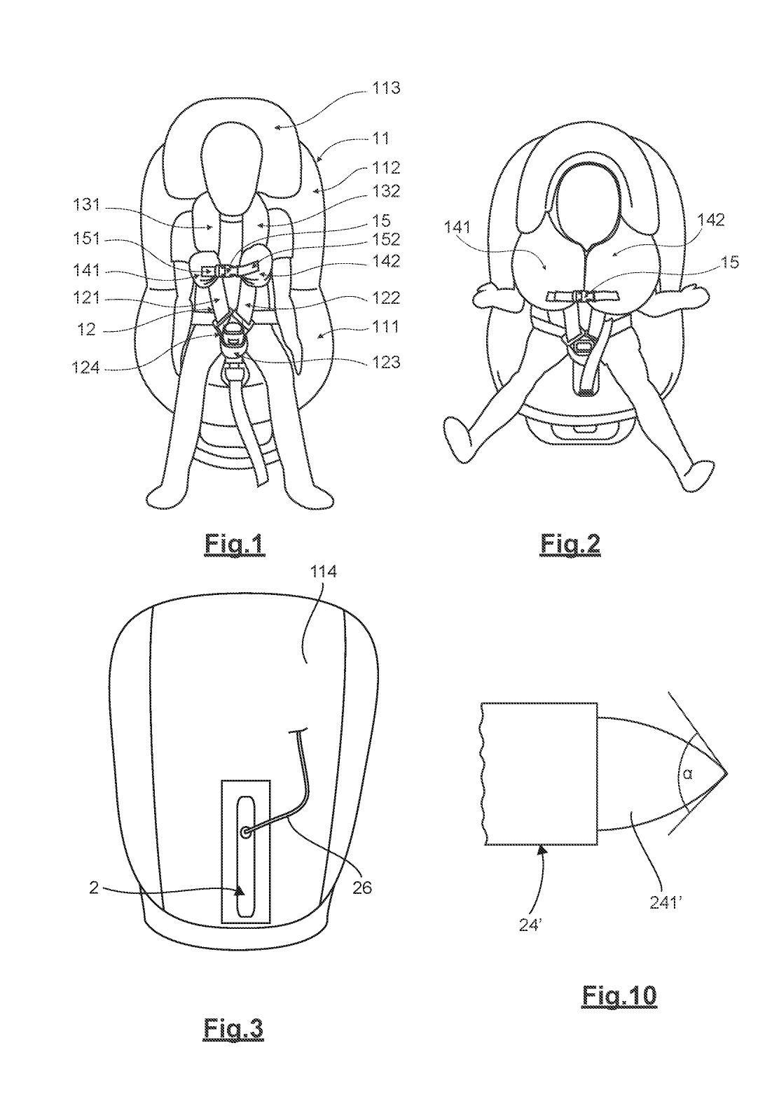

FIG. 3 shows the rear of the car seat of FIGS. 1 and 2, provided with a pyrotechnic gas generator in accordance with the invention making it possible to inflate inflatable elements;

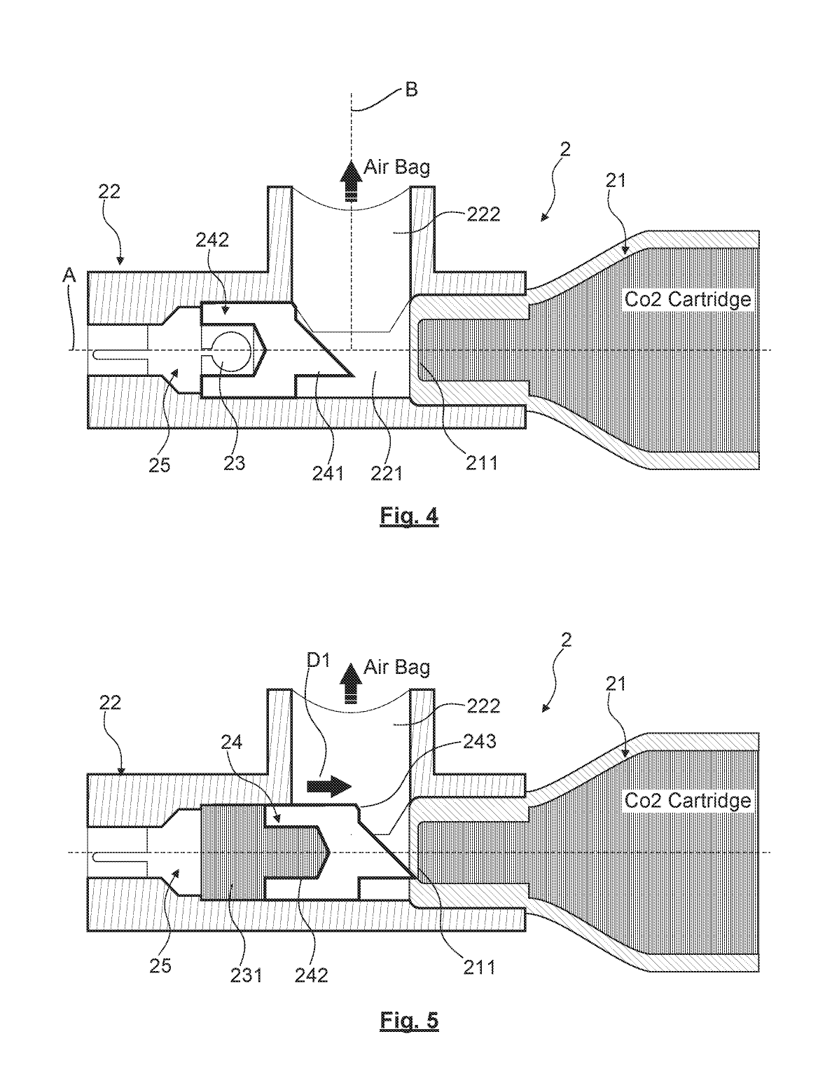

FIGS. 4 to 9 show the operation of the pyrotechnic gas generator in accordance with the invention;

FIG. 10 diagrammatically shows an example of a striker tip implemented in the pyrotechnic gas generator in accordance with the invention.

The invention therefore proposes a pyrotechnic gas generator for the inflating of one or of several inflatable safety bags (“airbag”) intended to be provided on child care devices.

The embodiment described in what follows relates to child car seats.

However, those skilled in the art understand that the same approach can easily be adapted to other child care devices, when they are provided with one or several inflatable safety bags.

As can be seen in FIG. 1, the child car seat 11 conventionally comprises a seat surface 111 and a seat back 112, here bearing headrest 113, which can be movable in height, in relation to the seat back 112.

The infant is maintained in this seat 11 using a harness 12, comprising two shoulder straps 121 and 122, intended to each be placed on one of the shoulders of the child, and extending substantially vertically over the torso of the latter, and a crotch supports 123.

When the harness is set in place, the two shoulder straps 121 and 122 and the crotch support 123 are made integral by a locking buckle 124. Each shoulder strap 121 and 122 carries a sheath 131, 132, taking position on the shoulders and/or the top of the body of the child, in order to improve his comfort and his safety.

In the embodiment described, each one of these sheaths 131 and 132 contains an inflatable safety element 141, 142 (of which only one end can be seen in FIG. 1, and extends beyond the sheaths). The rest of the inflatable safety elements are folded and housed in the sheaths, in such a way as to be deployed in an effective manner, in case of impact. The ends of the inflatable safety elements 141, 142 are connected by means of fastening 15, fastening them to one another, comprising two flexible portions, or strips, 151 and 152 each provided with a respectively male and female buckle element.

In case of substantial impact greater than a predetermined threshold, the two inflatable safety elements 141 and 142 are deployed automatically and very rapidly, from the sheaths 131 and 132, in order to protect in particular the head of the child, and limit its course of travel forwards, as shown in FIG. 2.

The two inflatable safety elements 141 and 142 are supplied by means of inflating in the form of a pyrotechnic gas generator 2, of which the operation is described in what follows in relation with the FIGS. 4 to 9.

As shown in FIG. 3, the gas generator 2 can be housed in the seat back 114 of the seat 11 in a housing provided for this purpose. This housing can, according to the cases, be placed in the seat back, the seat surface or the base of the car seat, or at any suitable location.

As shown in FIGS. 3 and 4, the gas generator 2 comprises a hollow body 22 comprising a cylindrical horizontal duct 221 wherein exits a duct, or opening, 222 for evacuating gases. This duct 222 is here cylindrical but can have other shapes. FIG. 4 shows the longitudinal axis A of the horizontal duct 221 and the longitudinal axis B of the duct 222 for evacuating gases. These two axes A, B are here arranged at 90°, but other inclination values of the duct 222 in relation to the duct 221 are possible. As such, the duct 222 for evacuating gases can be arranged on a slant in relation to the longitudinal axis A of the horizontal duct 221.

An open end of the horizontal duct 221, located to the right of the duct 222 for evacuating gases, is intended to receive the neck of a gas cylinder 21 of a suitable fluid. The fluid contained in the gas cylinder can in particular be a gas such as carbon dioxide (CO2), helium, nitrogen, or any other fluid that is suitable for allowing the immediate inflating of the two inflatable safety elements 141, 142. The neck of the bottle can be screwed into the open end of the horizontal duct 221.

A first end of a gas diffuser tube 26, which is here a flexible duct, is connected to the fluid supply inlet (not shown) of the inflatable safety elements 141, 142, with its second end being connected to the duct 222 for evacuating gases from the gas generator 2.

In addition to the gas reserve (bottle of gas) 21, the gas generator 2 comprises a pyrotechnic unit mounted in the other end of the horizontal duct 221, located to the left of the duct 222 for evacuating gases. This pyrotechnic unit is comprised of a pyrotechnic charge (or explosive) 23, means for igniting 25 the pyrotechnic charge 23 and a striker 24, shown in FIG. 4.

The pyrotechnic charge 23 has the form of a monolithic fuel cell (propellant for example) which produces a gas by being ignited and by burning. The pyrotechnic charge 23 is located in a combustion chamber 242 arranged inside the striker 24, which makes it possible to limit the encumbrance of the gas generator 2. The combustion chamber 242 exits into the rear planar surface 244 of the striker 24 which is, in the position of FIG. 4, in contact with the means for igniting 25.

The cylindrical striker 24 (also called “bullet”) is slidably mobile according to two opposite directions in the horizontal duct 221 and has, in this example, at the front, a perforating bevelled tip 241 (another shape can be considered, in particular an ogive shape) oriented towards the gas cylinder 21. The bevelled tip 241 comprises an inclined surface in relation to the longitudinal axis A of the horizontal duct 221 and oriented towards the duct 222 for evacuating gases. The perforating tip 241 is surrounded by a annular collar 243.

In the initial position of FIG. 4, this perforating portion 241 is located opposite the duct 222 for evacuating gases, at a distance from the closing seal 211 of the gas cylinder 21.

Although this is not shown in the figures, the gas generator 2 is controlled by a microcontroller/electronic control unit (ECU). In case of need (impact, accident, deceleration exceeding a predetermined threshold, etc.), the microcontroller is able to emit an instruction to trigger the gas generator 2, in the form of an electrical signal which is transmitted to the means for igniting 25, in such a way as to provide the inflating of the two inflatable safety elements 141 and 142. The triggering of inflating during an impact must of course be done only in case of an impact that is sufficiently substantial. A suitable predefined threshold is therefore defined.

If this predefined threshold is exceeded, the means for igniting 25 trigger the combustion of the pyrotechnic charge 23 in the combustion chamber 242. As shown by the arrow D1 of FIG. 5, once the combustion gas 231 fully occupies the volume of the combustion chamber 242, it causes the displacement of the striker 24 in the horizontal duct 221, towards the gas cylinder (i.e. from the left to the right in FIG. 5).

In the position shown in FIG. 5, the end of the perforating portion 241 of the striker 24 is in contact with the closing seal 211 of the gas cylinder 21, and the combustion gas 231 is contained in the closed space located between the means for igniting 25 and the striker 24.

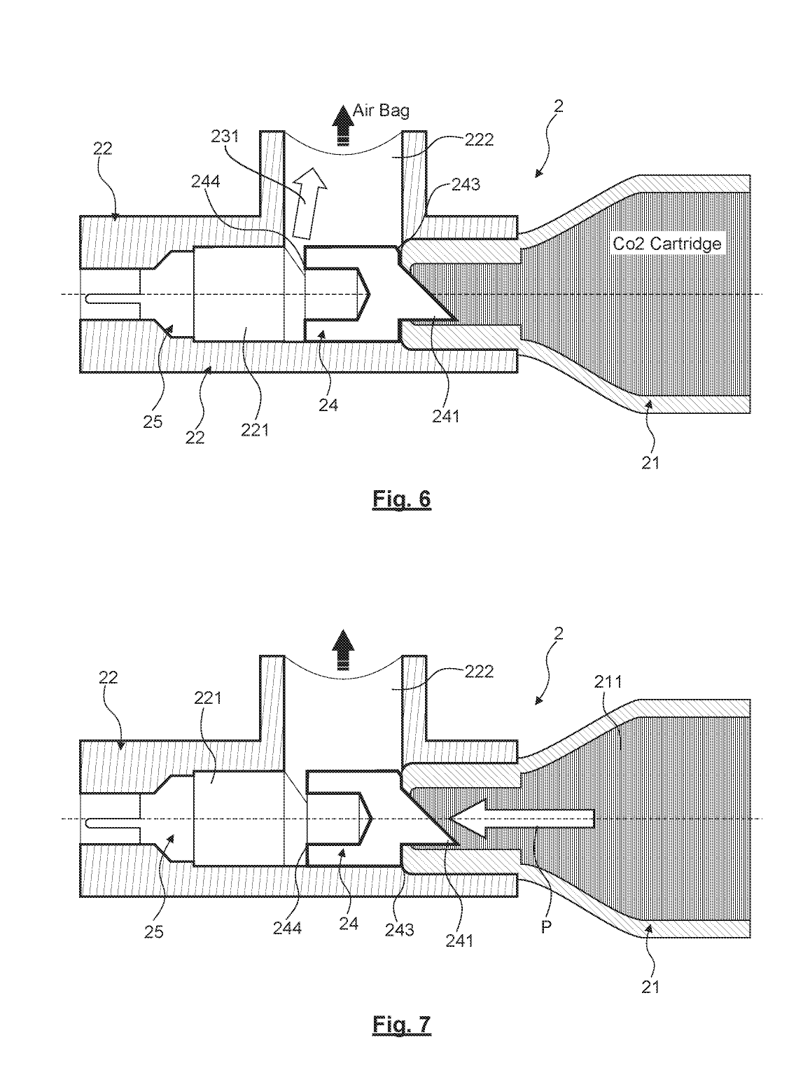

In FIG. 6, the striker 24 has further moved towards the gas cylinder 21 under the effect of the combustion gas 231 and is located in an open position. The rear surface 244 of the striker 24 is located opposite the duct 222 for evacuating gases. The combustion gas 231 has escaped into the duct 222 for evacuating gases that communicates with the tube 26 and the airbags. The degassing of the pyrotechnic charge 23 is therefore done towards the airbags. The perforating portion 241 of the striker 24 has pierced the closing seal 211 of the gas cylinder 21 and is located in the neck of the gas cylinder 21. The collar 243 is abutting against the neck of the gas cylinder 21, as such making it possible to maintain the body of the striker 24 outside of the gas cylinder 21 and the striker 24 to retract in order to direct the pressurised gas 211 towards the airbags.

With the gas cylinder 21 open and the combustion gas 231 purged, as shown in FIG. 7, the pressurised gas 211 stored in the gas cylinder 21 applies a pressure P on the perforating portion 241 of the striker 24 that is sufficient to retract the latter in the horizontal duct 221 (i.e. to displace it in the opposite direction, from the gas cylinder 21 towards the means for igniting 25). As the striker 24 retracts towards its initial position (as shown by the arrow D2 in FIG. 8), the pressurised gas coming from the gas cylinder 21 is directed into the duct 222 for evacuating gases and provides the inflating of the airbags.

As such, under the effect of the pressurised gas 211, the striker 24 retracts to a position for guiding the pressurised gas 211 in order to release the pressurised gas 211 into the duct 222 for evacuating gases (FIG. 8).

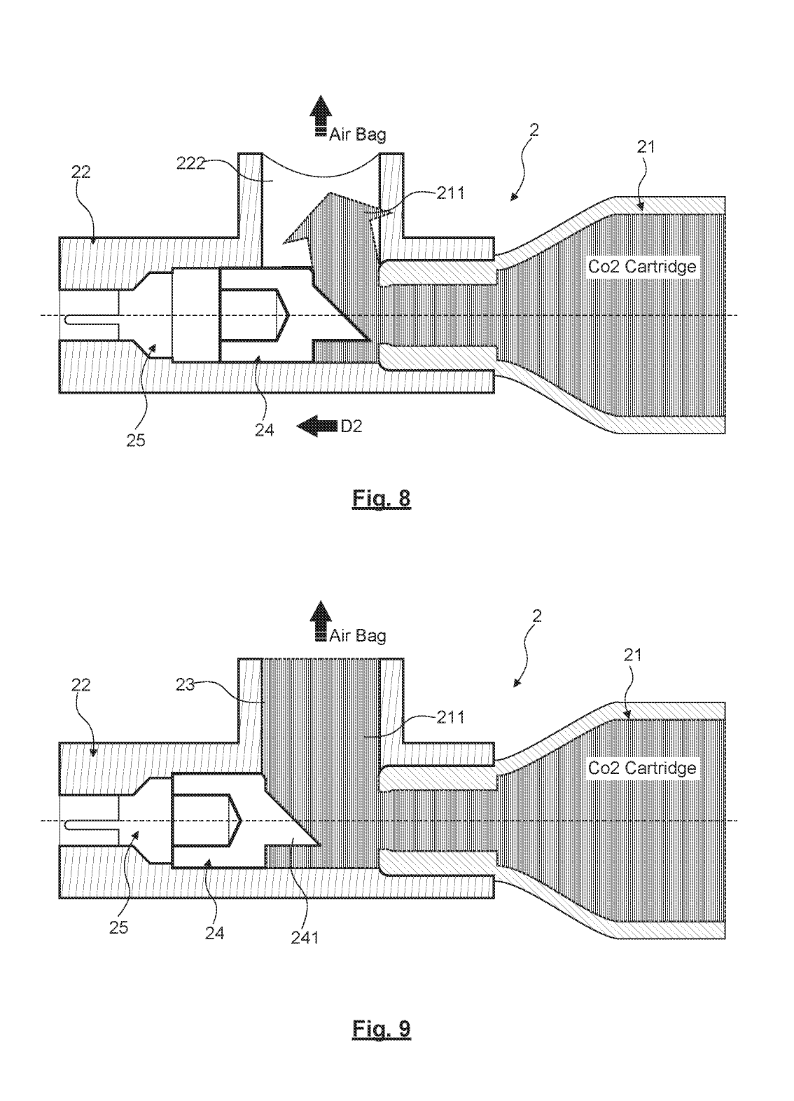

In FIG. 9, the striker 24 has retracted to its initial position and the pressurised gas 211 is directed into the duct 222 for evacuating gases, with the plane of the collar located on the angle formed by the duct 222 for evacuating gases and the horizontal duct 221.

Note that the striker 24 can have an intermediate position located between the initial position (FIG. 4) and the opening position of the gas cylinder 21 (FIGS. 6 and 7).

### Other Aspects and Alternatives

In the embodiment described hereinabove, the striker 24 has a bevelled tip 241.

A striker having an end as a tip or in the shape of a pyramid can be implemented. However, although those skilled in the art would logically consider these shapes for piercing a seal, the inventors have observed that such shapes do not allow for an optimum opening of the seal of the gas cylinder.

It was however observed by the inventors that an ogive shape allows for an optimum opening of the seal 211 of the gas cylinder 21 and better circulation of the gas around the tip of the ogive. A striker 24′ having a front end 241′ in the shape of an ogive is shown in FIG. 10. The angle α (alpha) of the two arcs of a circle forming the ogive end can be more or less substantial than that shown in FIG. 10.

Note that the striker 24 is mounted “tightened” at the rear portion (i.e. the side of the means for igniting) in order to provide for a maintaining of the latter during the entire life of the car seat. The rest of the body of the striker 24 is mounted with play in order to facilitate the displacement thereof during the triggering of the charge in particular.

Moreover, the invention does not apply solely to car seats, but can also be implemented in other child care devices, such as strollers, nacelles, seats for bicycles, etc.

1-12. (canceled)

13. A pyrotechnic system comprising a gas generator for airbag(s) comprising
at least one pyrotechnic charge and an ignitor configured to ignite said charge triggered during a predetermined condition,
a reservoir containing a pressurised gas and having a mouth that is closed by a sealing member,
a first duct communicating with the reservoir, and
a second duct for evacuating gases from the first duct and that communicates with at least one airbag,
the gas generator further comprising a striker located in the first duct and which can be displaced in a first step, when the predetermined condition is fulfilled, by the combustion gases generated by the pyrotechnic charge in the direction of the sealing member, from an initial position to an open position, so as to pierce the sealing member using means for piercing carried by said striker,
said striker able to be returned, once the sealing member is pierced, by the pressurised gas stored in the reservoir, to the initial position, the pressurised gas escaping from the reservoir being directed into the first duct and toward and into the second duct for evacuating gases,
wherein, in the initial position, the striker is located on one side of the second duct for evacuating gases, with the mouth of the reservoir being located on the other side of the second duct for evacuating gases in the duct, and in that the pyrotechnic charge is arranged at least partially in a housing included in said striker.

14. The pyrotechnic system, according to claim 13, wherein the housing is coupled to a rear face of the striker and the means for piercing is coupled to an opposite front face of the striker.

15. The pyrotechnic system, according to claim 13, wherein the means for piercing has an ogive shape or a bevelled shape.

16. The pyrotechnic system according to claim 13, wherein the means for piercing is surrounded by a shoulder intended to abut against edges bordering the mouth of the reservoir, and the means for piercing is sized to penetrate at least partially into said mouth of the reservoir (21).

17. The pyrotechnic system according to claim 16, wherein the housing is coupled to a rear face of the striker and the means for piercing is coupled to an opposite front face of the striker.

18. The pyrotechnic system according to claim 17, wherein a longitudinal axis (B) of the second duct for evacuating gases is substantially inclined in relation to an axis perpendicular to a longitudinal axis (A) of the first duct.

19. The pyrotechnic system according to claim 17, characterised in that when the shoulder is abutting against edges bordering the mouth of the reservoir, the rear face of the striker is located opposite the second duct for evacuating gases in such a way as to define a passage for the combustion gases towards the second duct for evacuating gases.

20. The pyrotechnic system according to claim 19, characterised in that a longitudinal axis (B) of the second duct for evacuating gases is substantially inclined in relation to an axis perpendicular to a longitudinal axis (A) of the first duct.

21. The pyrotechnic system according to claim 17, wherein the means for piercing has an ogive shape or a bevelled shape.

22. The pyrotechnic system according to claim 13, further comprising a child care device able to receive a child and coupled to the gas generator.

23. The pyrotechnic system according to claim 22, wherein the child care device comprises a seat, said gas generator is housed in a seat back of the seat, in at least lateral flanks, and/or in a base of the seat.

24. The pyrotechnic system according to claim 22, wherein the child care device further comprises a harness having two shoulder straps arranged to be extended from the shoulders along the torso of a child, and each one of the shoulder straps bears an inflatable safety element, able to be inflated in case of an impact greater than a predetermined threshold.

25. The pyrotechnic system according to claim 24, wherein the child care device comprises a seat, said housed in the seat back, in at least lateral flanks, and/or in a base of the seat.

26. The pyrotechnic system according to claim 22, wherein the child care device is one of a car seat, a stroller, a nacelle, or a seat for a bicycle.
